(19) United States
(12) Patent Application Publication
(10) Pub. No.: US 2007/0250386 A1
(43) Pub. Date: Oct. 25, 2007

(54) ENERGY EFFICIENT HOMEOWNERSHIP MORTGAGE PROGRAM

(76) Inventor: Ronald P. Wyckoff, Des Moines, IA (US)

Correspondence Address: DORSEY & WHITNEY LLP;INTELLECTUAL PROPERTY DEPARTMENT, 801 GRAND, SUITE 3900, DES MOINES, IA, 50309, US

(21) Appl. No.: 11/743,888

(22) Filed: May 3, 2007

Related U.S. Application Data
(63) Continuation-in-part of application No. 11/248,913, filed on Oct. 11, 2005.
(60) Provisional application No. 60/616,976, filed on Oct. 8, 2004.

(51) Int. Cl. G06Q 30/00

(52) U.S. Cl. 705/14

(57) ABSTRACT

A program for encouraging homebuyers and current homeowners to purchase more efficient HVAC equipment at the time they purchase a home or refinance a home loan is described. Realtors, bankers, lenders, mortgage brokers, and like individuals involved in the purchase or refinancing of a home present an opportunity to purchase energy efficient HVAC equipment to a client at a time when the purchase price of the equipment can be included in the mortgage or refinance loan. The realtors, bankers, lenders, mortgage brokers, and other individuals presenting the opportunity to the client act as marketers or salespeople for the program and the new equipment. These new salespeople work with a facilitator who coordinates the efforts of everyone involved in the transaction. The program provides the client with lower total homeownership costs through utility and maintenance savings. This program could potentially create hundreds of thousands of new salespeople (i.e. realtors, mortgage brokers, lenders, and other people involved in the purchase of a home or refinance of a home loan) that could illustrate to potential clients the positive cash flow they could receive, with no upfront costs, merely by installing new energy efficient HVAC equipment in their home.

This application is a continuation-in-part of U.S. patent application Ser. No. 11/248,913, filed Oct. 11, 2005, which claims priority from U.S. Provisional Application No. 60/616,976, filed Oct. 8, 2004, both of which Applications are hereby incorporated in their entirety by reference.

### BACKGROUND

This invention relates generally to a program to encourage homebuyers and current homeowners to install energy efficient heating, ventilation, and air conditioning (“HVAC”) equipment. More specifically, the invention relates to a program wherein the purchase price of the new energy efficient HVAC equipment is incorporated into a mortgage.

It is well known that replacing existing furnaces and air conditioning units with newer, more efficient units, can result in significant financial savings for the home owner due to lowered energy costs. However, many home owners cannot afford to pay the up-front cost associated with installing the new units. They may be reluctant to finance such a purchase, either because of prohibitively high interest rates associated with doing so with a consumer credit card, or because of relatively high origination fees associated with a consumer-type loan for purchasing such units. Additionally, the amortization time on a loan associated with a furnace may be short enough that, at least in the short term, the monthly payment associated with the loan for the furnace is greater than the monthly savings in energy costs. Moreover, many consumers are simply not aware of the potential savings available by switching to a higher efficiency unit.

### SUMMARY OF THE INVENTION

The program of the present invention solves many of these problems. According to the program, a marketer, which could include a HVAC dealer or installer, a real estate agent, home seller, mortgage broker, lender, or any of a number of people involved in the sale of a home, informs a homebuyer of the option of replacing the existing furnace and/or air conditioning unit in the house being purchased with new, more energy efficient units. Alternatively, a homeowner wishing to refinance is presented with this option. The homebuyer or homeowner is informed that the cost of the new units may be included in the mortgage for the home.

Specific cost figures associated with including the purchase price of the new heating and air conditioning equipment in the mortgage loan are calculated, as well as the expected monthly energy savings to be realized by switching to the new equipment. In many instances, the total monthly homeownership cost, which includes the mortgage payment and energy costs, will be lower when the homebuyer or homeowner replaces existing HVAC equipment with new, more energy efficient equipment. Thus, the program, uniquely, defines total monthly homeownership cost to include both the mortgage amount and utility/energy costs. The total monthly homeownership cost can be lowered by purchasing energy efficient equipment. In many instances, the program uses this fact to market the equipment, and/or program. In this way, the option of purchasing new energy efficient HVAC equipment appeals to consumers that wish to lower their total homeownership costs. Moreover, by using real estate agents, home sellers, mortgage brokers, lenders and other people involved in the sale or refinance of a home to market the new HVAC equipment, the program creates a new sales force that could include hundreds of thousands of people.

The program is therefore beneficial to homebuyers and homeowners, who can lower their monthly payments associated with any given home. It is beneficial to lenders because they can provide higher value loans. It is beneficial to real estate agents and mortgage brokers because homebuyers or homeowners can afford to buy or refinances houses having higher values, which result in higher commissions. It is beneficial to home sellers because it provides an incentive to buy, more buyers can be qualified, and it may eliminate or reduce any credit that the buyer may require in order to replace the existing HVAC system. It is beneficial for the furnace and air conditioner manufacturer and/or supplier because additional sales will be made. Furthermore, it is beneficial to the environment because it encourages the switch to more energy efficient HVAC equipment.

### BRIEF DESCRIPTION OF THE DRAWINGS

FIG. 1 is a diagram illustrating the flow of information, money, and equipment according to one embodiment of the present invention wherein a real estate agent is the marketer of new HVAC equipment;

FIG. 2 is a diagram illustrating the flow of information, money, and equipment according to one embodiment of the present invention wherein a mortgage broker is the marketer of new HVAC equipment;

FIG. 3 is a diagram illustrating the flow of information, money, and equipment according to one embodiment of the present invention wherein a lender is the marketer of new HVAC equipment;

FIG. 4 is a diagram illustrating the flow of information, money, and equipment according to one embodiment of the present invention wherein either a homebuyer is already aware of the option to include the purchase price of new HVAC equipment in a mortgage loan, or an HVAC installer is the marketer of the new HVAC equipment;

FIG. 5 is a diagram illustrating the flow of information, money, and equipment according to one embodiment of the present invention wherein a seller is the marketer of new HVAC equipment;

FIG. 6 is an illustrative flow chart showing one embodiment of the process of the present invention.

FIG. 7 is an example of a bid sheet that may be used in conjunction with the present invention.

### DETAILED DESCRIPTION OF PREFERRED EMBODIMENTS

The present invention relates to a method and system for encouraging homebuyers or current homeowners to replace existing HVAC equipment with new more efficient HVAC equipment when they purchase a home or refinance an existing home loan. By coordinating the efforts of a marketer with HVAC installers, homebuyers and persons wishing to refinance an existing home loan are able to lower their expected cost of owning a home by replacing HVAC equipment when they buy a house or refinance or otherwise take out a loan such as a home equity loan. The marketer may be a real estate agent, mortgage broker, lender, home seller, or any of a number of other people involved in the sale of a home. Alternatively, the HVAC installer may market the equipment so that the marketer and HVAC installer are one in the same. In the preferred embodiment, a facilitator is used to help coordinate the efforts of all involved, facilitate the flow of information between the parties, calculate certain values, and prepare materials for presentation to the homeowner/homebuyer. It should be understood that while the application is disclosed for use in association with heating ventilation and air conditioning equipment, the program may be applied to other energy efficiency improving products including, but not limited to, new windows, improved insulation, new water heaters, and the like. Likewise, it is understood that while “home,” “homeowner,” “homebuyer” and like terms are used, the application and process described herein may be used with condominiums, apartments, lofts, businesses and any other building or structure in which HVAC equipment or other energy efficient products may be used.

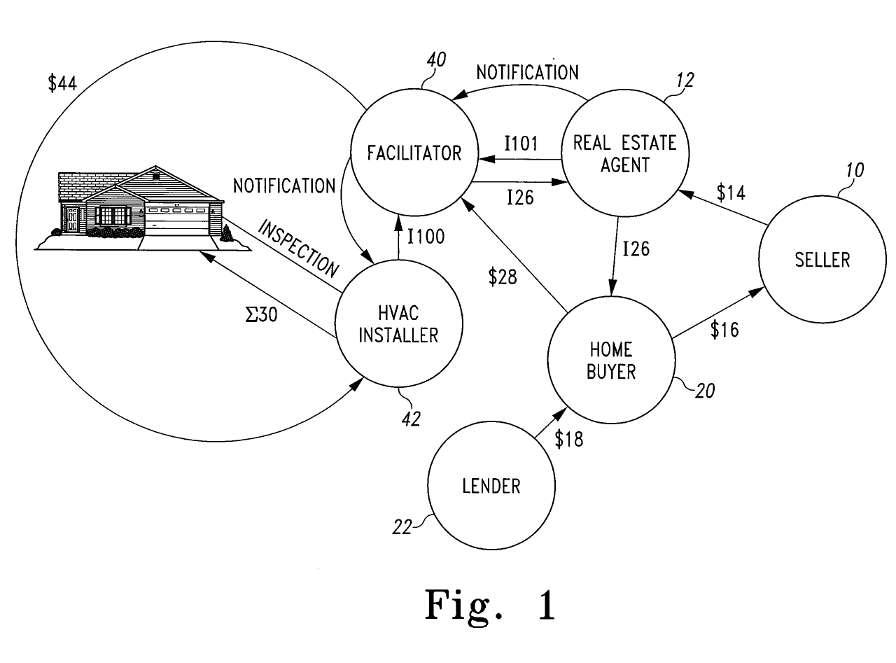

FIG. 1 shows the flow of information, money, and equipment according to one embodiment of the present invention in which a real estate agent is used to market HVAC equipment. The invention envisions that a seller 10 is selling a home which includes existing HVAC equipment, including, for example, a furnace and/or air conditioning unit. The present invention is most advantageous when the existing HVAC equipment is old and inefficient. It should be noted, however, that recent advances in technology have resulted in significant recent gains in efficiency. Therefore, it is common for even relatively new existing HVAC equipment to be relatively inefficient compared to available replacement equipment.

In one embodiment, the seller 10 will have retained a real estate agent 12 to help in marketing and selling the house. The seller 10 will pay to the real estate agent 12 a commission 14 from the proceeds of the sale of the house. A homebuyer 20 is purchasing the home from the seller 10 for an agreed upon price 16. The homebuyer 20 may use the same or a different real estate agent (not shown) to help in finding the home, negotiating the selling price, and advising the homebuyer regarding the home buying process. For the purpose of the present invention, either arrangement will work. If the homebuyer 20 does have a separate real estate agent, the seller's real estate agent 12 will typically split the commission 14 paid by the seller 10 with the buyer's real estate agent.

In order to have the money to pay the purchase price 16 for the home to the seller 10, the homebuyer 20 will typically need to obtain a loan in the form of a home mortgage 18 from a lender 22. The lender 22 will typically be a bank, savings and loan, credit union, or similar lending institution. The homebuyer 20 will take the money from the loan 18, and pay it to the seller 10 as part of the purchase price 16 for the home. The homebuyer 20 will then make installment payments, typically on a monthly basis, to the lender paying back interest as well as principle on the loan. Commonly, the amortization period for such a mortgage loan will be somewhere between 15 and 30 years. Some, or all, of the interest paid by the homebuyer to the lender may be tax deductible.

Thus far, a conventional sale and purchase of a home has been described. The present invention, as best seen in FIG. 1, adds new features to this standard transaction. The real estate agent 12, or the separate real estate agent used by the buyer, may notify a facilitator 40 of the potential home purchase. The facilitator 40, may then notify an HVAC installer 42 and arrange for the HVAC installer 42 to conduct an inspection of the existing HVAC equipment to determine information about the equipment such as, but not limited to, the make, model, and age of the equipment. The HVAC installer 42 provides this information 100 to the facilitator 40. In addition, the real estate agent 12 and/or HVAC installer may provide the facilitator 40 with information 101 regarding other properties of the house, such as, but not limited to, the size and type of house. In a preferred embodiment, this information is provided to the facilitator 40 in the form of a bid. Using the information 100 and 101 received from the real estate agent 12 and/or the HVAC installer 42, the facilitator 40 determines an expected monthly cost for operating the existing HVAC equipment, an expected cost for providing and/or installing new energy efficient HVAC equipment 30, and an expected cost for operating the new HVAC equipment 30. These values are calculated using known and/or published efficiency values obtained from the manufacturer. Alternatively, such values may be obtained from resources such as www.energy.gov. Also, the facilitator 40 calculates an expected mortgage payment amount and a second expected mortgage payment amount which second mortgage amount includes the cost of replacing the HVAC equipment. The facilitator 40 then provides this information 26, including the expected costs for operating the HVAC equipment and the expected mortgage payment amounts, to the real estate agent 12 for presentation to the homebuyer 20. Preferably, this information 26 is contained in an illustrative document or quote showing the current and potential values, but oral, electronic, and other forms of communication may be acceptable for the purposes provided.

The real estate agent 12 then provides this information 26 to the homebuyer 20. Using the information provided, the homebuyer 20 makes an informed decision regarding whether he or she will replace the existing HVAC equipment in the home and include the cost for said replacement in the mortgage for the home.

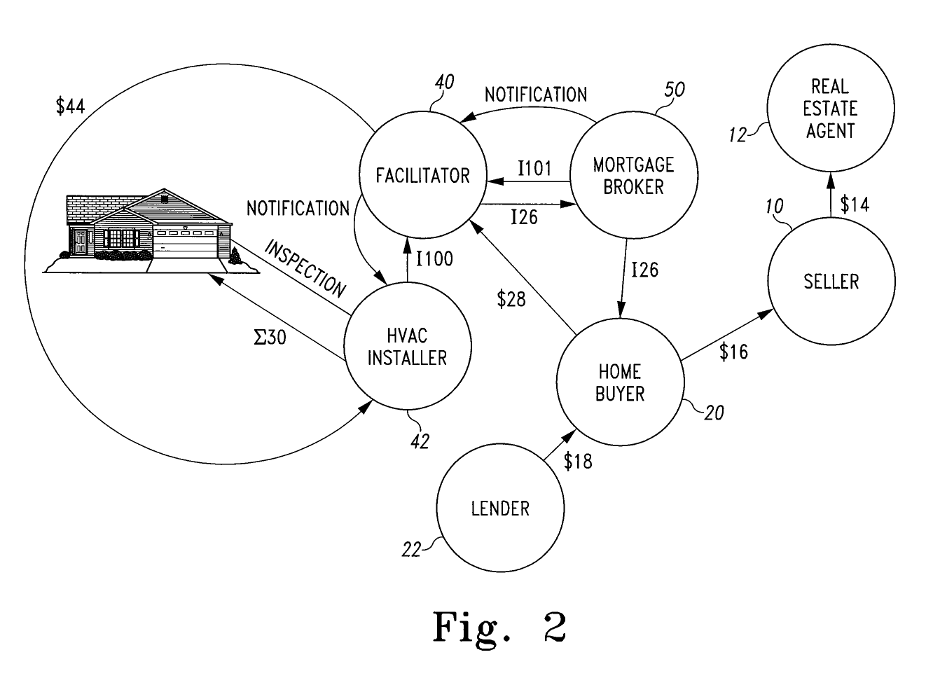

FIG. 2 illustrates another embodiment of the present invention wherein the process is initiated by a mortgage broker 50. Sometimes a homebuyer 20 enlists the assistance of a mortgage broker 50 in securing a home mortgage 18 from a lender 22. The mortgage broker 50 normally receives information regarding the home and the homebuyer, such as, but not limited to the size and type of house the homebuyer wishes to purchase, from the homebuyer 20. The mortgage broker uses this information to obtain information from lenders regarding specific loans for which the homebuyer may qualify. This information could include, but is not limited to, the interest rate and term of repayment of the various home mortgages 18 for which the homebuyer 20 qualifies. The mortgage broker 50 then assists the homebuyer 20 in choosing a home mortgage 18.

In the embodiment of FIG. 2, the mortgage broker 50 notifies the facilitator 40 of the potential home purchase. The facilitator 40, may, subsequently, notify an HVAC installer 42 and arrange for the HVAC installer 42 to conduct an inspection of the existing HVAC equipment to determine information about the equipment such as, but not limited to, the make, model, and age of the equipment. The HVAC installer 42 may then provide this information 100 to the facilitator 40 as described. In addition, the mortgage broker 50 and/or HVAC installer may provide the facilitator 40 with information 101 regarding other properties of the house, such as, but not limited to, the size and type of house. Using the information 100 and 101 received from the mortgage broker 50 and/or the HVAC installer 42, the facilitator 40 determines an expected monthly cost for operating the existing HVAC equipment, an expected cost for providing new energy efficient HVAC equipment 30, and an expected cost for operating the new HVAC equipment 30, calculated as described herein. The facilitator 40 may likewise calculate the first expected mortgage payment and second expected mortgage payment including the cost of replacing the HVAC equipment. Alternatively, the expected mortgage payments may be calculated by the mortgage broker 50 and communicated to the facilitator, since he or she will have access to information on various loan options, and experience in calculating estimates for mortgage payments. The facilitator 40 provides this information 26, including the expected costs for operating the HVAC equipment and the expected mortgage payments, to the mortgage broker 50 for presentation to the homebuyer 20 in the manner described herein.

The mortgage broker 50 provides the information 26 to the homebuyer 20. Using the information provided, the homebuyer 20 makes an informed decision regarding whether he or she will replace the existing HVAC equipment in the home and include the cost in the mortgage for the home.

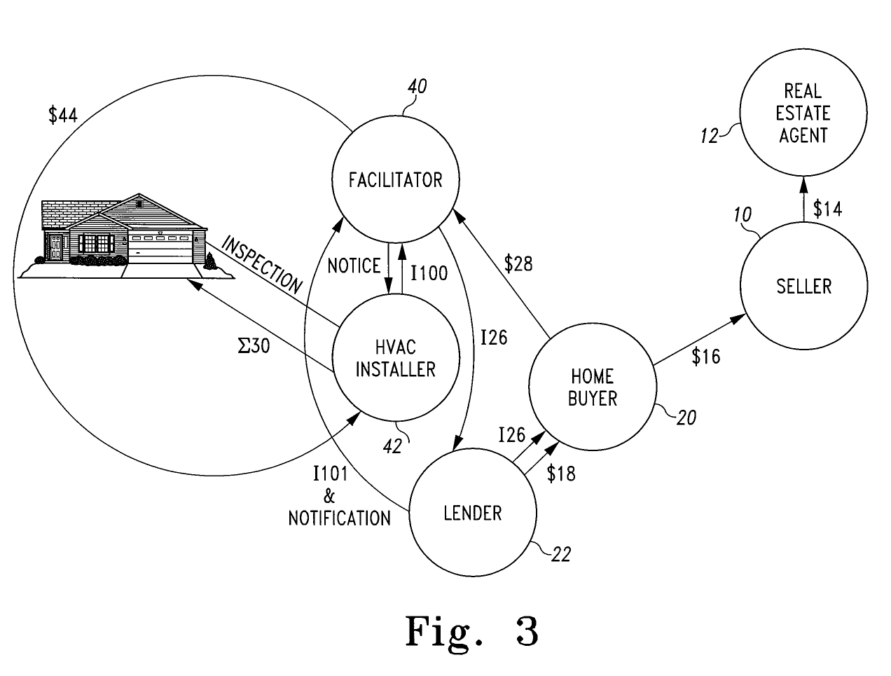

FIG. 3 illustrates yet another embodiment of the present invention wherein a lender 22 is used to market HVAC equipment. Instead of using a mortgage broker, a homebuyer 20 may approach a lender 22 directly in order to obtain a home mortgage 18. The lender 22 normally receives information regarding the homebuyer and the home from the homebuyer 20, including the size and type of house.

As FIG. 3 illustrates, the lender 22 may notify the facilitator 40 who arranges for the HVAC installer 42 to inspect the existing HVAC equipment to determine information such as, but not limited to, the make, model, and age of the equipment. The HVAC installer 42 may provide this information 100 to the facilitator 40 as described. In addition, the lender 22 and/or HVAC installer may provide the facilitator 40 with information 101 regarding other properties of the house, such as, but not limited to, the size and type of house. Using the information 100 and 101, the facilitator 40 determines an expected monthly cost for operating the existing HVAC equipment, an expected cost for providing new energy efficient HVAC equipment 30, and an expected cost for operating the new HVAC equipment 30, calculated as described herein. Also, the facilitator 40 and/or lender calculates an expected mortgage payment amount and a second expected mortgage payment amount which includes the cost of replacing the HVAC equipment. This information 26, including the expected costs for operating the HVAC equipment and the expected mortgage payments, is provided to the lender 22 for presentation to the homebuyer 20, in the forms described with respect to the previously discussed embodiments. The lender 22 provides the information 26 to the homebuyer 20, who uses the information to decide whether to replace the existing HVAC equipment in the home and/or include the cost in the mortgage for the home.

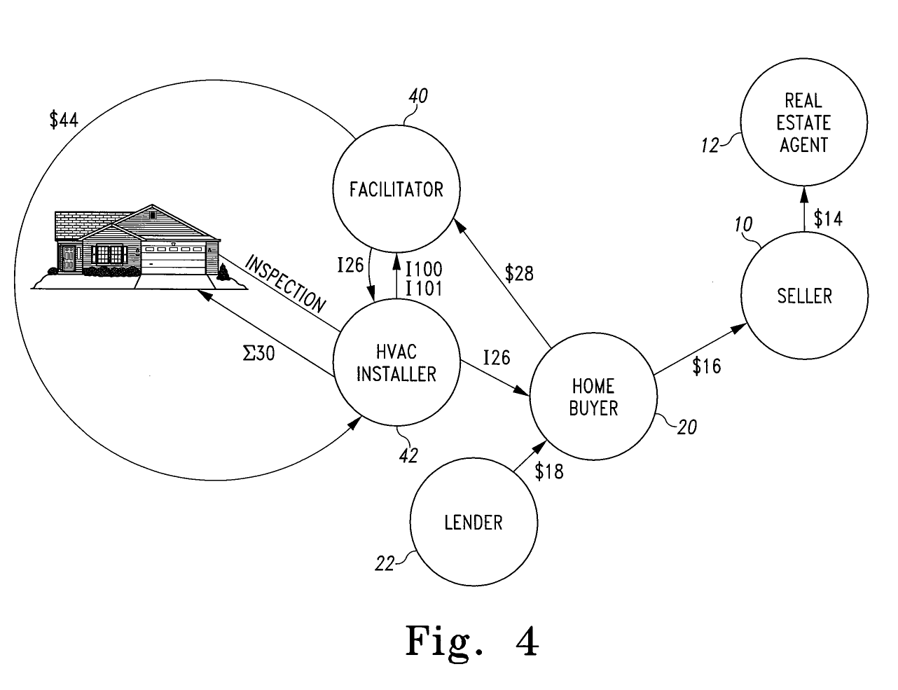

FIG. 4 shows an embodiment of the invention wherein the HVAC installer 42 markets the new HVAC equipment 30 providing the option of including the replacement costs associated with the new HVAC equipment in a mortgage 18. In this embodiment, a homebuyer 20 may become aware of the option to include the cost of the new equipment in the purchase price of the home by receiving advertisements distributed by the HVAC installer 42, or through hearing of the program from friends or family, or by any of a number of other ways the program may be advertised. Alternatively, the HVAC installer 42 may suggest the option to the homebuyer 20 during the course of inspecting the existing HVAC equipment, for example, as part of a pre-sale home purchase inspection or other maintenance service call.

In the embodiment of FIG. 4, the HVAC installer 42 may provide information 100 and 101 such as, but not limited to, the make, model, and age of the equipment and the size and type of house to the facilitator 40 as described. Using the information 100 and 101, the facilitator 40 determines the expected monthly cost for operating the existing HVAC equipment, expected cost for providing new energy efficient HVAC equipment 30, and expected cost for operating the new HVAC equipment 30 as described herein. The facilitator 40 may also calculate the expected mortgage payments with and without the cost of replacing the HVAC equipment. The facilitator 40 may then provide this information 26, including the expected costs for operating the HVAC equipment and the expected mortgage payments, to the HVAC installer 42 for presentation to the homebuyer 20. The HVAC installer 42 then subsequently presents this information 26 to the homebuyer 20, who uses the information to decide whether to replace the existing HVAC equipment in the home and include the cost in the mortgage for the home.

The embodiments of the invention described in FIGS. 2, 3, and 4 apply not only to the initial financing of a home, but could apply equally well to refinancing of an existing mortgage, or to obtaining a home equity loan.

For example, in the embodiment described in FIG. 2, the homebuyer may instead be a current homeowner who desires to refinance her existing mortgage loan. Much in the same way as a homebuyer may enlist the assistance of a mortgage broker in obtaining a mortgage, a current homeowner may enlist the assistance of a mortgage broker in refinancing her existing mortgage loan. In the case of a refinancing, the process would proceed much in the same way as described above and illustrated in FIG. 2. After being approached by a homeowner to assist in obtaining a refinancing loan, the mortgage broker may notify a facilitator who would then arrange for a HVAC installer to inspect the existing HVAC equipment. The facilitator receives information regarding the home and the existing HVAC equipment. The facilitator then uses the information to calculate expected costs for providing the new energy efficient HVAC equipment, operating the new energy efficient HVAC equipment, and operating the existing HVAC equipment. The facilitator (or the mortgage broker) may also determine a first expected mortgage payment which does not include the cost of the new equipment, and a second expected mortgage payment which does include the cost of the new equipment. The mortgage broker provides all of this information to the homeowner so that she could make an informed decision whether to include the cost of replacing the existing HVAC equipment in the mortgage.

Similarly, the homebuyer in the embodiment described in FIG. 3 may instead be a current homeowner that wishes to refinance her current mortgage loan or to obtain a home equity loan. As described above and illustrated in FIG. 3, the homeowner may approach a lender in order to obtain such a loan. After being approached by a homeowner to assist in obtaining a refinancing loan or a home equity loan, the lender may notify a facilitator who arranges for a HVAC installer to inspect the existing HVAC equipment. The process would proceed in much the same way as described with respect to the embodiment of FIG. 3.

Also, the homebuyer in FIG. 4 could instead easily be a current homeowner wishing to refinance or to obtain a home equity loan. The homeowner would have been made aware of the option of including the cost of replacing existing HVAC equipment in the new mortgage or home equity loan through advertisements distributed by an HVAC installer, through referrals from friends or family, or any of a number of other ways. Alternatively, the HVAC installer may present the option to the homeowner when he has been called to the home to perform service/maintenance on the existing equipment, or when he has been called to the home in connection with the homeowner's desire to replace the existing equipment. The process would proceed in much the same way as described above and illustrated in FIG. 4.

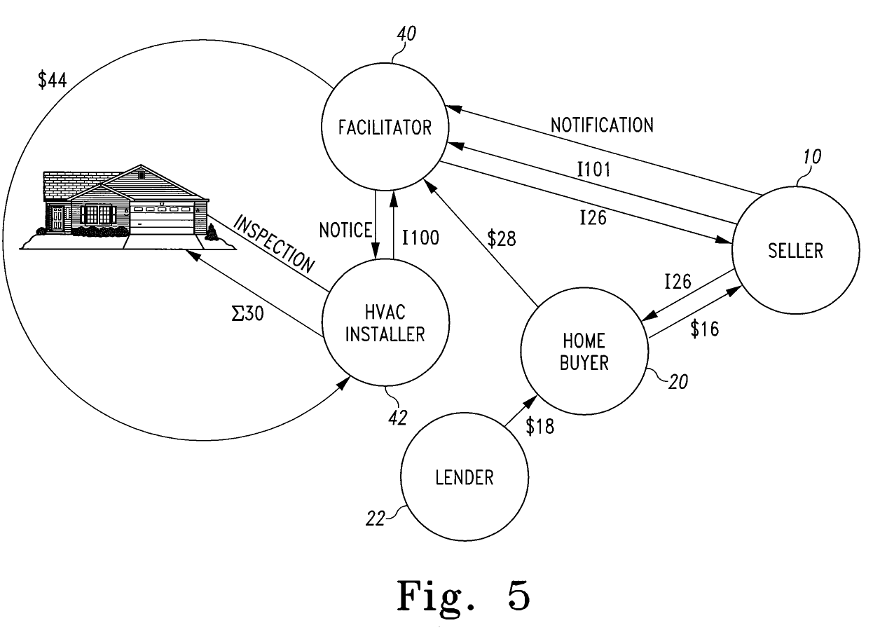

Yet another embodiment of the present invention wherein the HVAC equipment is marketed by a home seller 10 is described in FIG. 5. In the embodiment of FIG. 5, the home seller 10 notifies a facilitator 40 of a pending home sale. The facilitator 40 arranges for a HVAC installer 42 to inspect the existing HVAC equipment and provide the facilitator 40 with information 100 such as, but not limited to the make, model, and age of the equipment. The facilitator also receives other information 101 about the home such as, but not limited to the size and type of house. Using the information 100 and 101, the facilitator 40 determines an expected monthly cost for operating the existing HVAC equipment, an expected cost for providing new energy efficient HVAC equipment 30, and an expected cost for operating the new HVAC equipment 30. Also, the facilitator 40 calculates an expected mortgage payment and a second expected mortgage payment which includes the cost of replacing the HVAC equipment. The facilitator 40 then provides this information 26, including the expected costs for operating the HVAC equipment and the expected mortgage payments, to the home seller 10 for presentation to the homebuyer 20, preferably in the form of an illustrative document. The home seller 10 then provides this information 26 to the homebuyer 20, who uses the information to decide whether to replace the existing HVAC equipment in the home and include the cost in the mortgage for the home.

Home ownership may be thought of as having six areas of expense: principal, interest, taxes, utilities, maintenance, and insurance. The overall cost of homeownership may therefore be determined by adding, or summing, all of these factors. Ideally the overall cost of homeownership is determined on a monthly basis because most mortgages and utilities require payment on a monthly basis. Other time periods could also be effectively used without departing from the invention. The benefits of the present invention are realized because the homebuyer 20 or homeowner is reducing the overall costs of home ownership. Specifically, the additional amount of principal and interest due each month because of the new HVAC equipment is more than offset by the expected savings in utilities and maintenance costs. By lowering the overall cost of home ownership, and by including the purchase price of the new HVAC equipment 30 into the mortgage loan 18, the monthly cash flow for the homebuyer 20 or homeowner is improved.

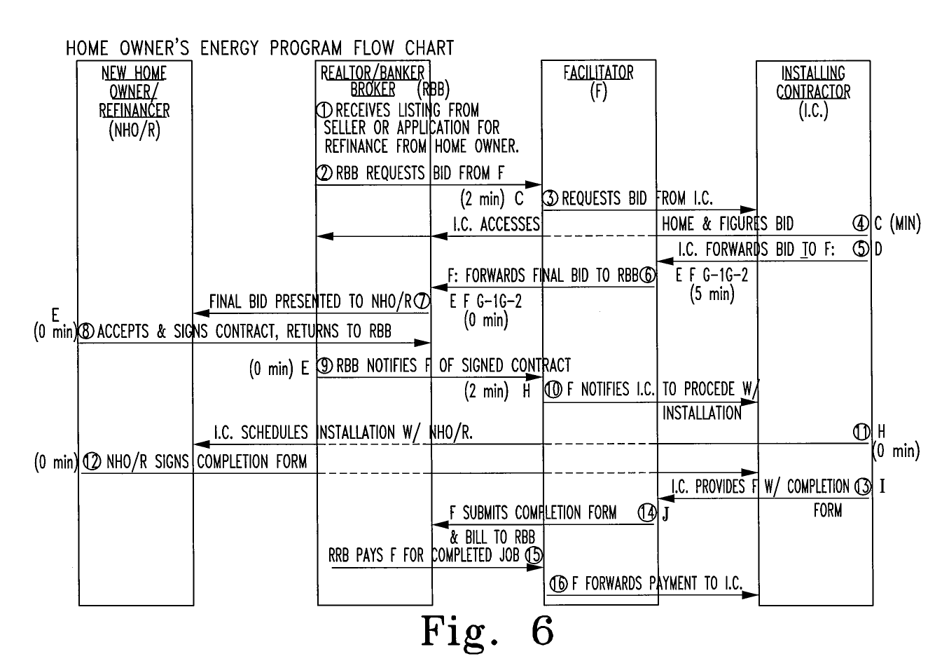

FIG. 6 illustrates one non-limiting example of the process flow according to an embodiment of the homeownership energy program. As can be seen, the illustrated program primarily involves a new homeowner or refinancer, a realtor/banker/broker, a facilitator, and an installing contractor. In the illustrated embodiment, the realtor/banker/broker receives a listing from the seller or an application for refinancing from the homeowner and subsequently requests a bid from the facilitator. The facilitator requests a corresponding bid from the installing contractor for the proposed installation of a new HVAC system in the home. The installing contractor prepares the bid by accessing the home of the owner/refinancer, completing a bid form, and forwarding same to the facilitator. The facilitator subsequently prepares and forwards a final bid, which is prepared using the calculations described with respect to the above discussed embodiments, to the realtor/banker/broker who presents the final bid to the new homeowner/refinancer. The new homeowner/refinancer may accept the bid or offer and, in a preferred embodiment, signs an agreement to move forward with the installation as proposed. This agreement is returned to the realtor/banker/broker who then notifies the facilitator of receipt of the agreement. The facilitator instructs the installing contractor to schedule and proceed with the installation. The installing contractor schedules the installation with the new homeowner/refinancer and proceeds with the installation at the scheduled time. Upon completion of the installation, the new homeowner/refinancer executes a completion form indicating that installation of the HVAC system is completed and returns the form to the installing contractor. The installing contractor subsequently provides this form to the facilitator who then notifies or submits the completion form to the realtor/banker/broker. The realtor/banker/broker subsequently pays the facilitator with funds from the new homeowner/refinancer or releases the fimds from escrow to the facilitator for the completed HVAC installation. Facilitator then forwards payment to the installing contractor or other necessary parties to complete the process. A unique aspect of the present embodiment is that when funds are held in escrow, the installing contractor is guaranteed prompt and full payment upon completion of the installation. While a specific embodiment of the process is disclosed, the flow of information and parties responsible therefore may be altered without parting from the overall scope of the present embodiment.

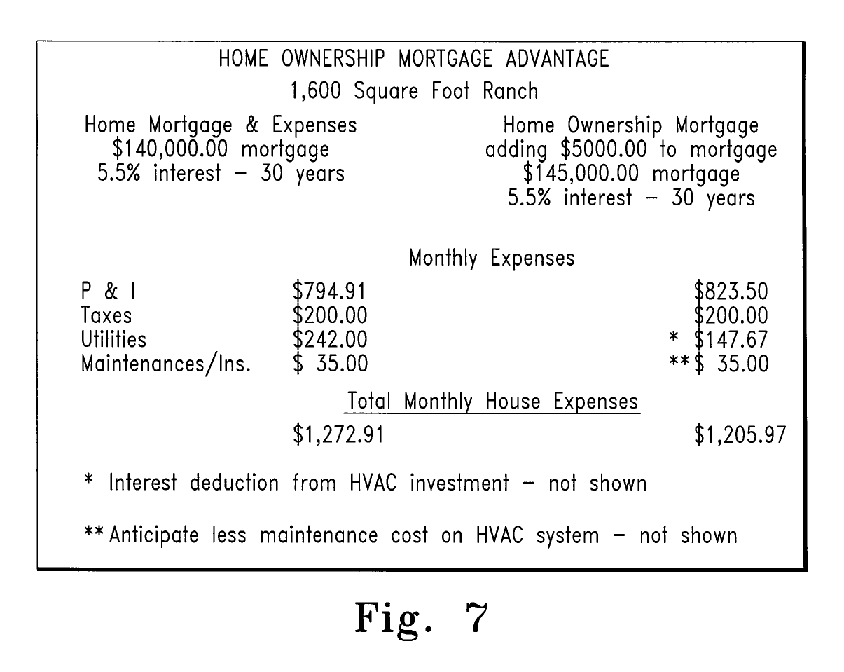

Unfortunately, many homebuyers do not realize the potential cash flow savings available to them. Therefore, there is a need for the present invention that utilizes communication between a marketer (e.g. real estate agent 12, mortgage broker 50, lender 22, or home seller 10), a facilitator 40, HVAC installers 42, and homebuyers 20. The marketer notifies a facilitator 40, who receives information from an HVAC installer 42 and the marketer such as home style, square footage, location, venting, and make, model, and age of the existing HVAC equipment. The facilitator uses the information to create a bid or offer for presentation to the homeowner or homebuyer 20. An example of a form for a written offer is shown in FIG. 7. The details and style of an offer may naturally vary from that shown in FIG. 7. The offer may include a breakdown of the cost of the equipment, cost of installation, as well as a breakdown of estimated monthly savings in energy costs. Importantly, the offer includes a comparison of the total monthly cost of ownership for the home as it currently exists and the expected monthly cost of ownership if new HVAC equipment 30 is installed.

The expected mortgage payments may be calculated by the facilitator 40 based on a specific expected or approximated interest rate and loan term. Alternatively, the expected mortgage payments can be provided by the lender 22, mortgage broker 50, real estate agent 12, or any of a number of other parties involved. Similarly, the costs for providing the new energy efficient HVAC equipment, operating the new energy efficient HVAC equipment, and operating the existing HVAC equipment can be calculated by the facilitator 40 based on information provided by the HVAC installer 42, or these costs may be calculated by the HVAC installer 42 and then provided to the facilitator. Either way, the information is eventually put into a form that a homebuyer/homeowner can easily understand.

As discussed herein, using the information provided, the homebuyer 20 or homeowner makes an informed decision. If the homebuyer 20 decides to purchase new HVAC equipment 30, the marketer provides the homebuyer 20 with the necessary paperwork to order the appropriate equipment from the facilitator 40. This paperwork creates an agreement between the homebuyer 20 and the facilitator 40. According to the agreement, the homebuyer 20 agrees to finance the indicated new HVAC equipment as part of the homebuyer's mortgage loan 18, refinance loan, or home equity loan. In return, the facilitator 40 may direct the HVAC installer 42 to install the new HVAC equipment 30 in the home. When the loan closes, a portion 28 of the proceeds from the mortgage loan 18, refinance loan, or home equity loan are paid to the facilitator 40. It should be appreciated that alternatives may be acceptable. For instance, money may be paid directly by the lender 22 to the facilitator 40, or may be paid to the homebuyer 20 or homeowner who then pays the facilitator 40, or payment using a two-party check, in which the facilitator is a party. Preferably, the proceeds 28 to pay for the HVAC equipment and installation of the HVAC equipment may be paid to an escrow account at closing, and then distributed by the lender to the facilitator 40 upon satisfactory installation of the HVAC equipment 30 into the purchased home. This insures prompt and complete payment upon completion of the installation. Also, once the HVAC equipment has been installed, the facilitator 40 may pay the installer 42 an installation fee 44.

As described in the preferred embodiment, the facilitator 40 performs many functions. The facilitator 40 performs as a coordinator for all the participants in the process. The facilitator 40 may act to find HVAC suppliers (which could be HVAC manufacturers or HVAC distributors) to provide equipment to installers 42 who actually perform the installation. It is presumed that the facilitator 40 purchases the new HVAC equipment from a preferred supplier (not shown), and provides the equipment to the installer 42. Most preferably, the facilitator 40 will provide standardized forms and literature for the marketer who will be marketing the new equipment. Again, the marketer may be a real estate agent 12, mortgage broker 50, seller 10, lender 22, an HVAC installer 42, the facilitator itself, and/or a number of other people involved in the transaction. The facilitator 40 will also provide standardized forms and literature to the installer 42. The facilitator 40 coordinates finding suitable marketers, HVAC equipment suppliers, and installers 42 in desired geographic locations. The standard forms may include offer, bid documents, purchase agreements, advertising materials, and the like.

The installer 42 also may have several duties. The installer 42 may evaluate the home for current efficiency and recommend new HVAC equipment 30. The installer 42 preferably communicates the materials needed for the new HVAC equipment to the facilitator 40, so that the facilitator can review and authorize, if applicable, the proposed new HVAC equipment. The installer 42 may receive the new HVAC equipment 30 and make arrangements for its installation. The installer 42 may inform the facilitator 40 when the job has been completed, and may submit any necessary rebate and warranty papers. The installer 42 may also perform normal warranty service as needed.

The present invention provides benefits for all involved, and should facilitate increased installation of high efficiency HVAC equipment. The homebuyer 20 or homeowner benefits by having a lower monthly cost of home ownership. In addition to the factors already discussed, the homebuyer may expect to reap additional savings in the form of an income tax write-off based on the interest paid for financing the HVAC equipment. Rebates may be available from energy companies in response to installing high-efficiency equipment. Maintenance costs can be expected to be reduced. Additionally, the new equipment often provides superior performance in terms of evenness of heat and comfort. Peace of mind is also increased by the reliability of new HVAC equipment as opposed to used. Finally, the homebuyer 20 or homeowner may feel good about conserving energy.

Mortgage lenders 22 benefit by being able to lend higher principal mortgages that include the cost new HVAC equipment. There is less chance of default because the homebuyers have a decreased total cost of ownership. More buyers may qualify for loans as a result of the lowered total cost for home ownership. It therefore provides a marketing tool for mortgage lenders.

Real estate agents benefit by being able so sell more and higher priced houses by virtue of the lowered total ownership cost. Additionally, they are likely to receive fewer sales conflicts that can result from faulty existing HVAC equipment. Listing sellers may be likely to seek out real estate agents who provide this service, resulting in increased listings and listing commissions.

Finally, society as a whole benefits from the increased use of high efficiency HVAC equipment and corresponding lowered use of energy.

Although various representative embodiments of this invention have been described above with a certain degree of particularity, those skilled in the art could make numerous alterations to the disclosed embodiments without departing from the spirit or scope of the inventive subject matter set forth in the specification and claims. For example, the role of the facilitator could be eliminated, or the marketer and the facilitator could be one in the same person. As a specific example, one could imagine the scenario where the real estate agent receives the information regarding the Existing HVAC Equipment and the home, calculates energy and mortgage costs for presentation to the homebuyer, and arranges for the installation of the equipment and the inclusion of the cost of the equipment in the home loan. However, using a facilitator provides the advantage that the facilitator can form relationships with all the necessary parties, coordinate the actions of all the parties, and provide standardized materials and forms. Similarly, those skilled in the art could make numerous other alterations to the disclosed embodiments without departing from the spirit or scope of the inventive subject matter set forth in the specification and claims.

1. A method of marketing HVAC equipment, the method comprising the steps of:
receiving information regarding a home's existing HVAC equipment;
determining an expected ongoing existing utilities cost for the existing HVAC system;
determining a first expected loan payment for the home with the existing HVAC system;
determining an expected cost of ownership for the home with the existing HVAC system equal to the first expected loan payment for the home plus the expected ongoing existing utilities cost;
determining a second expected loan payment for the home which includes the replacement cost for a replacement HVAC system;
determining an expected ongoing new utilities cost for the replacement HVAC system;
determining an expected cost of ownership for the home with the replacement HVAC system equal to the second expected loan payment for the home plus the expected ongoing new utilities cost;
creating a comparison of the expected cost of ownership for the home with the existing HVAC system with the expected cost of ownership for the home with the replacement HVAC system; and
presenting the comparison to a client.

2. The method of marketing HVAC equipment according to claim 1 wherein the step of presenting the comparison to the client is done by a marketer.

3. The method of marketing HVAC equipment according to claim 2 wherein the marketer is a mortgage broker.

4. The method of marketing HVAC equipment according to claim 2 wherein the marketer is a real estate agent.

5. The method of marketing HVAC equipment according to claim 2 wherein the marketer is a lender.

6. The method of claim 1 wherein the client is a person purchasing a home.

7. The method of claim 1 wherein the client is a person refinancing a home.

8. The method of claim 1 wherein the loan is a home equity loan.

9. The method of claim 2 further comprising the step of inspecting the home's existing HVAC equipment.

10. The method of claim 9 further comprising the step of installing the replacement HVAC system.

11. The method of claim 10 wherein the steps of inspecting the home's existing HVAC equipment and installing the replacement HVAC system are done by an HVAC installer.

12. The method of claim 11 wherein a facilitator coordinates the efforts of the marketer and the HVAC installer.
